(19) United States
(12) Patent Application Publication
(10) Pub. No.: US 2013/0257909 A1
(43) Pub. Date: Oct. 3, 2013

(54) TERMINAL DEVICE

(71) Applicant: KYOCERA CORPORATION, Kyoto (JP)

(72) Inventor: Shunsuke NAGATA, Daito-shi (JP)

(73) Assignee: KYOCERA Corporation, Kyoto (JP)

(21) Appl. No.: 13/828,629

(22) Filed: Mar. 14, 2013

(30) Foreign Application Priority Data
Mar. 28, 2012 (JP) 2012-074881

(51) Int. Cl. G09G 5/38

(52) U.S. Cl. CPC G09G 5/38
USPC 345/650

(57) ABSTRACT

A terminal device is disclosed. The terminal device includes a display unit, an acceleration sensor, a display controller and an operation unit. The acceleration sensor senses an acceleration of a body of the terminal device when the body is being tilted. The display controller displays a vertical screen on the display unit when the body is in a vertical orientation. The display controller also displays a horizontal screen on the display unit when the body is in a horizontal orientation. The display controller further switches between the vertical screen and the horizontal screen based on an output from the acceleration sensor. The operation unit accepts a setting of a sensitivity of the acceleration sensor. The display controller controls switching based on the sensitivity and the acceleration.

### CROSS-REFERENCE TO RELATED APPLICATION

The present application claims priority under 35 U.S.C. 119 to Japanese Patent Application No. 2012-074881, filed on Mar. 28, 2012, entitled “Terminal Device,” the content of which is incorporated herein by reference in its entirety.

### FIELD

The present invention relates to a terminal device such as a mobile telephone handset, a PDA (personal digital assistant), a tablet PC (personal computer), an electronic book reader, or an electronic dictionary terminal, and in particular to a terminal device that changes the display screen to a vertical or a horizontal screen in accordance with the inclination of the terminal device body toward the vertical direction or the horizontal direction.

### BACKGROUND

One conventional example of a terminal device having an acceleration sensor is a rectangular mobile telephone handset. The acceleration sensor of this mobile telephone handset detects the angle of inclination of the mobile telephone handset body (or simply, the body) by sensing the acceleration during the tilting of the body from a vertical orientation with respect to the ground to a parallel orientation with respect to the ground. By detecting the angle of inclination, the handset performs control so as to rotate the vertical screen and to switch to a horizontal screen. There is a desire for a terminal device in which, in accordance with the detection of the angle of the terminal device body sensed by the acceleration sensor, the angle of inclination at which the display is switched from a vertical screen to a horizontal screen or from a horizontal screen to a vertical screen can be set arbitrarily.

### SUMMARY

In an embodiment, a terminal device includes a display unit, an acceleration sensor, a display controller and an operation unit. The acceleration sensor senses an acceleration of a body of the terminal device when the body is being tilted. The display controller displays a vertical screen on the display unit when the body is in a vertical orientation. The display controller also displays a horizontal screen on the display unit when the body is in a horizontal orientation. The display controller further switches between the vertical screen and the horizontal screen based on an output from the acceleration sensor. The operation unit accepts a setting of a sensitivity of the acceleration sensor. The display controller controls switching based on the sensitivity and the acceleration.

In another embodiment, a method for operating a terminal device displays a vertical screen on a display unit when a body of the terminal device body is in a vertical orientation. The method also displays a horizontal screen on the display unit when the body is in a horizontal orientation. The method also switches between the vertical screen and the horizontal screen based on an output from an acceleration sensor. The acceleration sensor senses acceleration of the body when the body is being tilted. The method also accepts a setting of a sensitivity of the acceleration sensor. The method further controls switching between the vertical screen and the horizontal screen based on the sensitivity and the acceleration.

In further embodiment, a non-transitory computer readable storage medium comprises computer-executable instructions for operating a terminal device. The computer-executable instructions displays a vertical screen on a display unit when a body of the terminal device body is in a vertical orientation. The method also displays a horizontal screen on the display unit when the body is in a horizontal orientation. The method also switches between the vertical screen and the horizontal screen based on an output from an acceleration sensor. The acceleration sensor senses acceleration of the body when the body is being tilted. The method also accepts a setting of a sensitivity of the acceleration sensor. The method further controls switching between the vertical screen and the horizontal screen based on the sensitivity and the acceleration.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1A is a front elevation outer view of a mobile telephone handset as a terminal device according to an embodiment of the present invention, and FIG. 1B is a side elevation thereof.

FIG. 2 is a block diagram showing the constitution of the mobile telephone handset according to an embodiment.

FIG. 3 is a drawing showing the constitution of a sensitivity setting screen of an embodiment.

FIG. 4 is a flowchart describing the processing for setting a sensitivity of the acceleration sensor in the mobile telephone handset of an embodiment.

FIG. 5 is a flowchart describing the operation of switching the display screen to a horizontal direction or to a vertical direction in the mobile telephone handset of an embodiment.

FIG. 6A shows the vertical orientation of the mobile telephone handset of an embodiment with respect to the ground, FIG. 6B shows the orientation of the mobile telephone handset when the mobile telephone handset is inclined toward the horizontal direction from the vertical orientation, FIG. 6C shows a horizontal orientation of the mobile telephone handset, and FIG. 6D shows an orientation of the mobile telephone handset when the mobile telephone handset has been inclined toward a vertical direction from a horizontal orientation.

FIG. 7A shows a vertical screen displayed on the display of the mobile telephone handset of an embodiment, and FIG. 7B shows a horizontal screen.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding technical field, background, summary or the following detailed description. The present disclosure should be accorded scope consistent with the claims, and not limited to the examples described and shown herein.

Embodiments of the disclosure are described herein in the context of one practical non-limiting application, namely, an information-processing device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), ATM, personal handy phone system (PHS), lap top computers, TV's, GPS's or navigation systems, machining tools, pedometers, health equipments such as weight scales, display monitors and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

An embodiment for implementing the present invention (hereinafter, simply “embodiment”) will be described in detail below, with references made to the attached drawings.

### Constitution of the Embodiment

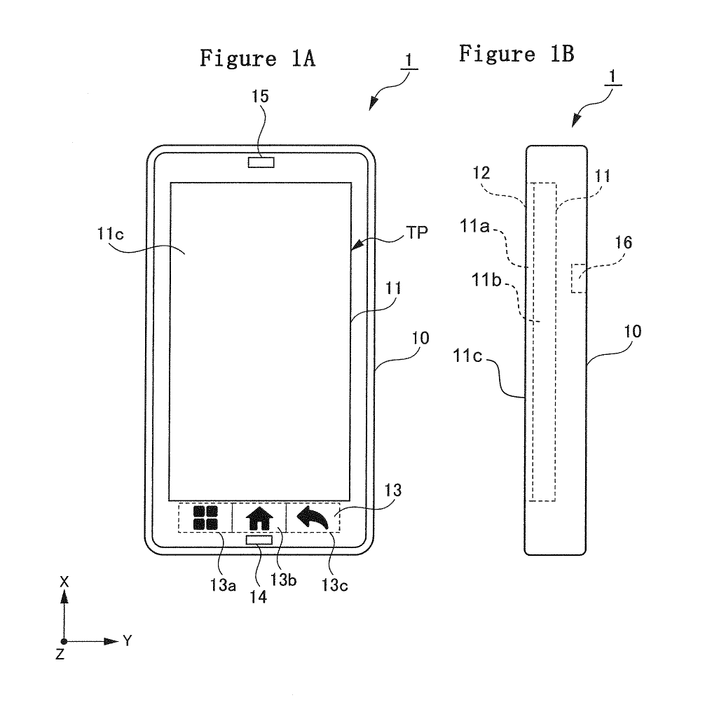

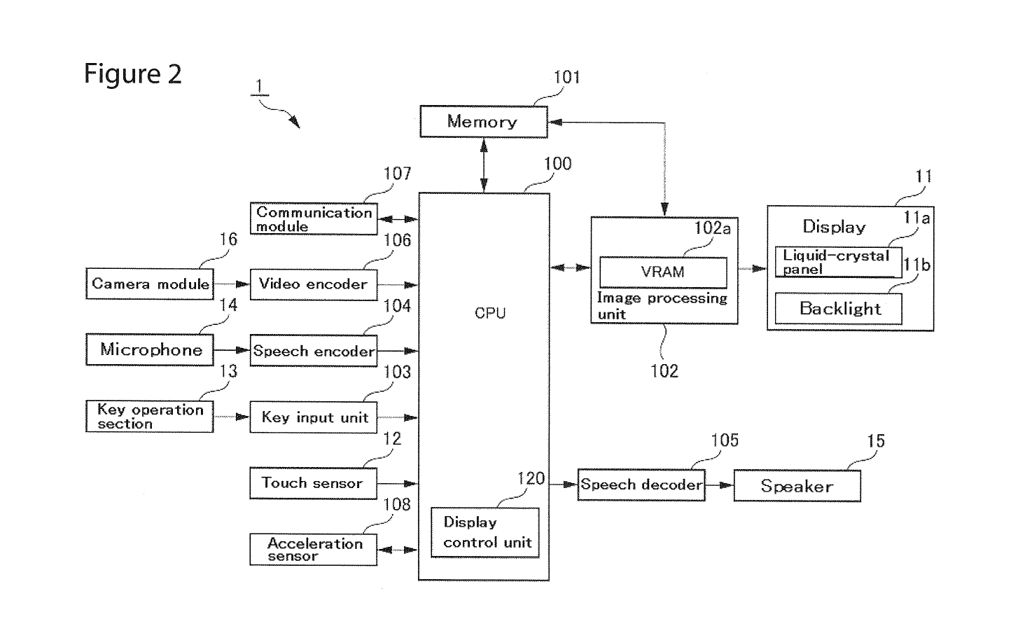

FIG. 1A is a front elevation outer view of a mobile telephone handset 1 as a terminal device according to an embodiment, and FIG. 1B is a side elevation thereof. FIG. 2 is a block diagram showing the constitution of the mobile telephone handset 1. The constitution of the mobile telephone handset 1 according to a present embodiment will be described using FIG. 1 and FIG. 2. The mobile telephone handset 1 has a thin, rectangular case 10. A touch panel TP is disposed on the front surface side of the case 10, and includes a display 11 as a display unit and a touch sensor 12 superposed over the display 11.

The display 11 includes a liquid-crystal panel 11a and a backlight 11b that illuminates the liquid-crystal panel 11a. The liquid-crystal panel 11a has, on the front thereof, a display surface 11c for displaying an image, the display surface 11c being visible to the outside. A home screen, on which icons of various application software or programs (referred to simply as applications) are arranged, and an execution screen, based on an application, are displayed on the display surface 11c. An organic EL (electro-luminescence) or other display element may be used in place of the liquid-crystal panel 11a.

The touch sensor 12 is formed over the display surface 11c and, because it is a transparent sheet, the display surface 11c can be seen through the touch sensor 12. The touch sensor 12 detects the position on the display surface 11c touched by a user (hereinafter, referred as input position), and outputs a position signal responsive to the input position to a CPU 100, which will be described later. The touching of the display surface 11c sometimes actually refers to touching a region of a cover that covers the touch sensor 12 corresponding to the display surface 11c.

Although the touch sensor 12 can be a capacitive-type touch sensor, it is not restricted to being a capacitive-type touch sensor, and can alternatively be an ultrasonic, pressure-sensitive, resistive-film, or optical detector type of touch sensor. A capacitive-type touch sensor may include first transparent electrodes and second transparent electrodes arranged in a matrix configuration, and may detect the input position by detecting a change in capacitance between the first and second transparent electrodes.

By a user touching the display surface 11c with his or her finger or with a contacting member such as a pen (referred to collectively for simplicity as “finger”), it is possible to perform various operations such as touching, tapping, and flicking. A key operation section 13 constituted by touch keys 13a, 13b, and 13c may be disposed at the bottom of the touch panel TP in the vertical direction. The touch keys 13a to 13c specifically may be a home key 13a, a setting key 13b, and a back key 13c. The home key 13a may be a key for displaying the home screen on the display surface 11c. The setting key 13b may be a key for displaying a setting screen on the display surface 11c. The user makes various settings on the setting screen. The back key 13c may be a key for returning a current screen displayed on the surface 11c to a prior screen one step before, when executing an application.

A microphone 14 is disposed on the lower part of the front surface side of the case 10 in the vertical direction, and a speaker 15 may be disposed on the upper part thereof. The user can converse by listening to a voice from the speaker 15 and speaking into the microphone 14. A camera module 16 may be disposed on the rear surface side of the case 10. A lens window (not shown) may be disposed on the rear side of the case 10, the image of a subject being captured by the camera module 16 via the lens window.

Additionally, the mobile telephone handset 1, as shown in FIG. 2, includes, in addition to the above-described constituent elements, a CPU 100, a memory 101, an image processing unit 102, a key input unit 103, an speech encoder 104, a speech decoder 105, a video encoder 106, a communication module 107, and an acceleration sensor 108. The CPU 100 further includes a display controller 120.

The image processing unit 102, in accordance with a control signal input from the CPU 100, may generate an image that is displayed on the display 11 and store the image data into a VRAM (video RAM) 102a. Additionally, an image signal that includes the image data stored in the VRAM 102a may be output to the display 11. The image processing unit 102 may output a control signal for controlling the display 11, and light or extinguish the backlight 11b of the display 11. In this manner, by the light that is emitted from the backlight 11b being modulated by the liquid-crystal panel 11a based on the image signal, an image is displayed on the display surface 11c of the display 11.

The key input unit 103 may output to the CPU 100 a signal responsive to a pressed key when any of the keys of the key operation unit 13 is pressed. The speech encoder 104 may convert a speech signal output in response to speech collected by the microphone 14 to a digital speech signal and output the signal to the CPU 100. The speech decoder 105 may subject a speech signal from the CPU 100 to decoding and D/A conversion and output the converted analog speech signal to the speaker 15.

The communication module 107 includes an antenna that transmits and receives radio waves for the purpose of phone calls and other communication. The communication module 107 may convert a signal input from the CPU 100 to a wireless signal, and transmit the converted wireless signal, via the antenna, to a base station or another communication apparatus. The communication module 107 may convert a wireless signal received via the antenna to a signal having a format usable by the CPU 100, and output the converted signal to the CPU 100.

The memory 101 may include ROM or RAM, and may store a control program for imparting control functionality to the CPU 100 and various applications. The memory 101 may be used as a working memory that stores various data temporarily used or generated during execution of an application.

The CPU 100, by controlling the camera module 16, the microphone 14, the communication module 107, the display 11, the speaker 15, and the like in accordance with a control program, may execute various applications, such telephone calls, camera functionality, e-mail, web browsing, maps, and a music player.

The acceleration sensor 108 may detect (or sense) the acceleration of the body of the mobile telephone handset 1 when it is being tilted. The acceleration sensor 108 is a three-axis sensor that senses acceleration occurring in the three axis directions, X-axis direction, Y-axis direction, and Z-axis direction shown in FIG. 1. When the mobile telephone handset 1 is tilted from the vertical direction toward the horizontal direction or from the horizontal direction toward the vertical direction, the acceleration may be sensed in accordance with the angle of inclination. Additionally, the acceleration sensor 108 may output to the CPU 100 an acceleration signal responsive to the detected acceleration signal. When the mobile telephone handset 1 is in the static state, the acceleration of gravity acting on the mobile telephone handset 1 may be detected by the acceleration sensor 108.

The display controller 120 may control the switching of the display, based on the output from the acceleration sensor 108, so as to display a vertical screen on the display unit if the body of the mobile telephone handset 1 is in a vertical orientation, and to display a horizontal screen on the display unit if the body of the mobile telephone handset 1 is in a horizontal orientation. The display control unit 120 may also control the switching of the display based on the sensitivity set by the operation unit.

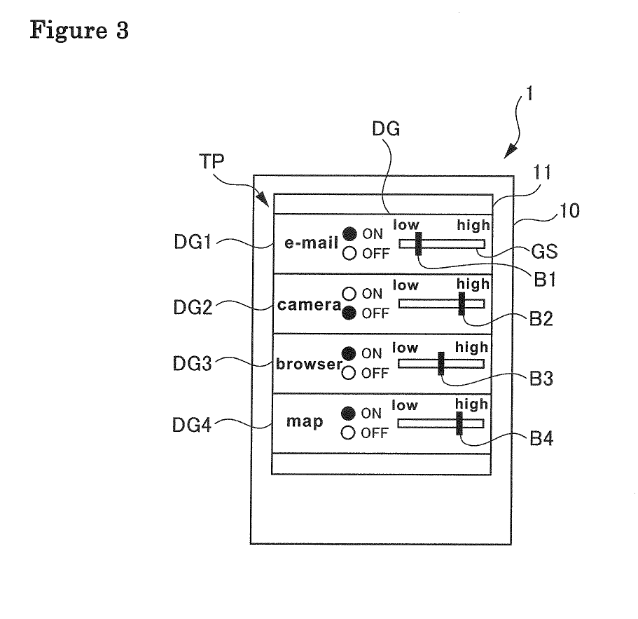

When the user performs a prescribed operation, a sensitivity setting screen DG such as shown in FIG. 3 is displayed as an operating section on the touch panel 11. The sensitivity of the acceleration sensor can be set by operating the sensitivity setting screen DG. The sensitivity setting screen DG includes a sensitivity setting screen DG1 for an e-mail application for sending and receiving e-mail (e-mail application screen), a sensitivity setting screen DG2 for an application for camera photography or the like (camera application screen), a sensitivity setting screen DG3 for an application to make a browser display (browser application screen), and a sensitivity setting screen DG4 for an application for map display (map application screen). The sensitivity setting screen DG may include additional sensitivity setting screens.

In this manner, the sensitivity setting screens DG1 to DG4 may be provided to enable setting of the sensitivity of the acceleration sensor 108 with respect to each of a plurality of previously set applications (e-mail, camera, browser, and map). The display controller 120, based on the setting operations by each of the sensitivity setting screens DG1 to DG4, may receive each of the sensitivity settings for the acceleration sensor 108 for each of the plurality of applications.

An ON/OFF button that accepts an operation that sets the sensitivity setting for the acceleration sensor 108 on and off may be provided in the sensitivity setting screen DG. If the user selects the OFF button for the acceleration sensor sensitivity setting, the display controller 120 accepts the operation that sets the acceleration sensor sensitivity to off, control being performed so that switching of the screen is not controlled. Each of the sensitivity setting screens DG1 to DG4 may display a sensitivity variation range GS of a certain width for setting the sensitivity of the acceleration sensor 108. Additionally, setting buttons B1, B2, B3, and B4 for arbitrary setting of the sensitivity may be displayed on each of the sensitivity variation ranges GS. Also, the range widths of the sensitivity variation ranges GS may be sensitivity widths that are scale-divided from 1 to 100, from the left to the right, or vice versa, in an example of FIG. 3. The values 1 and 100 may be, respectively, the lowest and highest values of sensitivity. The sensitivity ranges GS and the setting buttons B1, B2, B3, and B4 may be displayed only when the ON buttons are selected, and when the OFF buttons are selected may not be displayed or may be displayed with a lower contrast than when the ON buttons are selected.

In the example of FIG. 3, in the screen DG1 for the e-mail application, the acceleration sensor 108 sensitivity setting is set to on, and the sensitivity is set to 25 on the scale by the setting button B1. In the screen DG2 for the camera application, the acceleration sensor 108 sensitivity setting is set to off. In the screen DG3 for the browser application, the acceleration sensor 108 sensitivity setting is set to on, and the sensitivity is set to 50 on the scale by the setting button B3. In the screen DG4 for the map application, the acceleration sensor 108 sensitivity setting is set to on, and the sensitivity is set to 80 on the scale by the setting button B4.

Each of the set sensitivities from 1 to 100 is such that the screen switches when the angle reaches or exceeds a certain angle, and the acceleration sensor sensitivity may be associated with the angle of inclination of the body. For example, if the angle α is associated with the set sensitivity of 25 and the display controller 120 detects, based on the output from the acceleration sensor 108, that the mobile telephone handset 1 is inclined at an angle of α or greater, control is performed to switch the display direction, and if the angle of inclination is less than α, control is performed so that the screen display direction is not switched. When the acceleration sensor sensitivity is set to a low value, α becomes comparatively high value. On the other hand, the acceleration sensor sensitivity is set to a high value, α becomes comparatively low value.

As described above, in addition to setting the sensitivities of the acceleration sensor 108 to on or off for the individual applications separately (separate settings), it may be possible to set the sensitivity of the acceleration sensor 108 to on or off in common (overall setting), regardless of the application. In this case, if the overall setting and the separate settings are made simultaneously, although either can have priority, if the separate settings have priority, screen switching is done that more closely reflects the desires of the user.

### Operation of the Embodiment

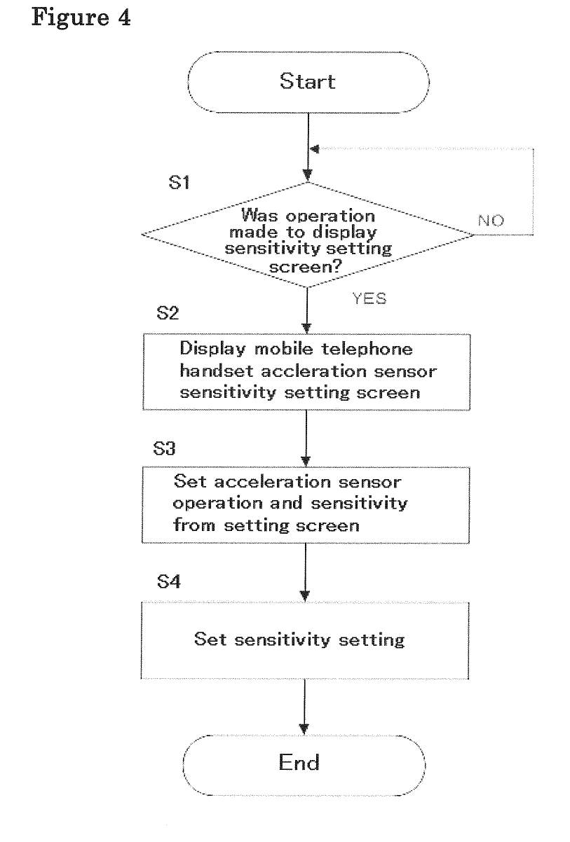

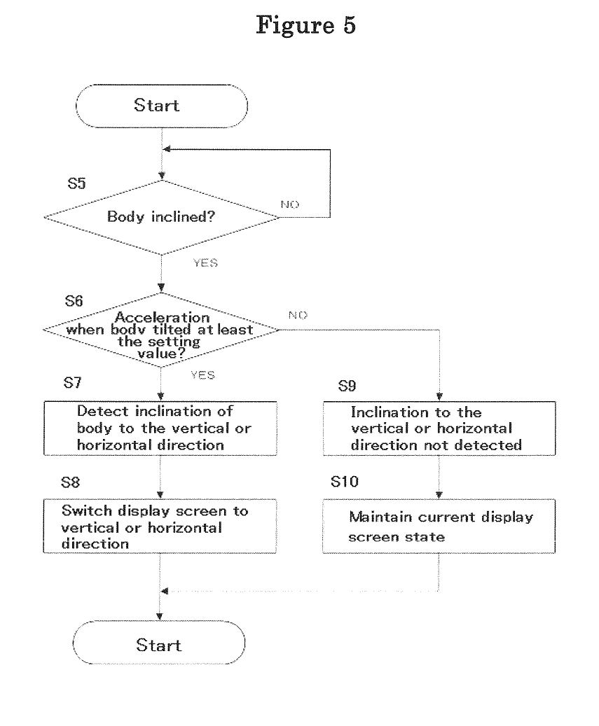

The operation of the acceleration sensor 108 sensitivity setting processing and the operation of switching the display screen to the horizontal direction or the vertical direction in the mobile telephone handset of the present embodiment will be described below in detail, with references made to the flowcharts of FIG. 4 and FIG. 5.

First, referring to FIG. 4, the acceleration sensor 108 sensitivity setting processing will be described. When the user makes an operation to display the sensitivity setting screen DG, the touch sensor 12 detects the operation (yes at step S1), and the display controller 120 displays the sensitivity setting screen DG shown in FIG. 3 (step S2).

The user touches the ON or OFF buttons of the sensitivity setting screen DG to set the acceleration sensor sensitivity setting to on or off, and slides the setting buttons B1 and B4 to set the sensitivity of the acceleration sensor 108 for each of the applications (step S3).

In this case, assume, as shown in FIG. 3, that in the screen DG1 for the e-mail application, the acceleration sensor 108 sensitivity setting is set to on, and the sensitivity is set to 25 on the scale, in the screen DG2 for the camera application, the acceleration sensor 108 sensitivity setting is set to off, in the screen DG3 for the browser application, the acceleration sensor 108 sensitivity setting is set to on, and the sensitivity is set to 50 on the scale, and in the screen DG4 for the map application, the acceleration sensor 108 sensitivity setting is set to on, and the sensitivity is set to 80 on the scale.

The display controller 120, based on the user operations, sets the sensitivities for each application (step S4).

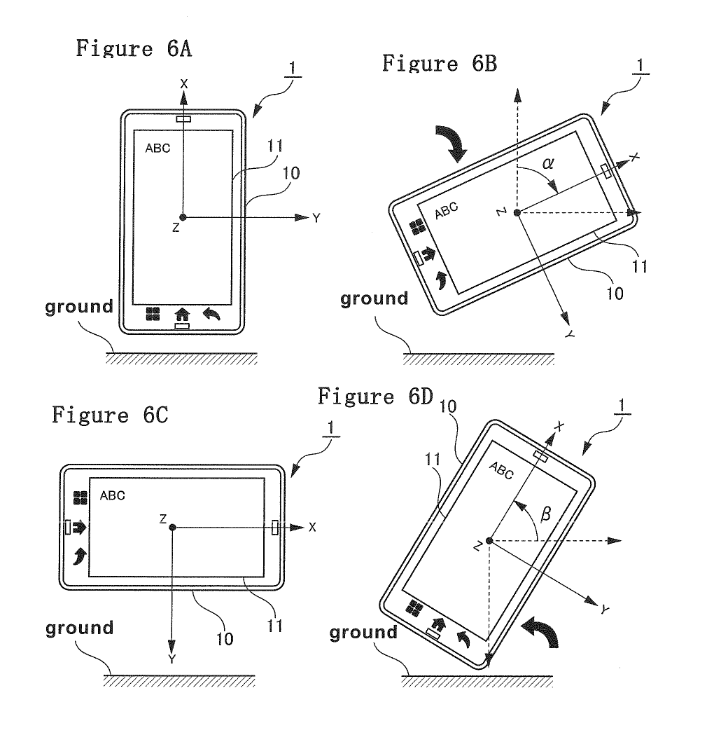

Next, referring to FIG. 5, the operation of switching the display screen to the horizontal direction or the vertical direction will be described. With the mobile telephone handset 1 currently oriented in the vertical direction with respect to the ground, as shown in FIG. 6A, assume that the user tilts the mobile telephone handset so that the X axis rotates in the direction of the Y axis, as shown in FIG. 6B (yes in step S5). When the mobile telephone handset 1 is inclined in this manner, the display controller 120 judges whether or not the acceleration from the acceleration sensor at the time of the tilting is at or above the sensitivity setting value (step S6).

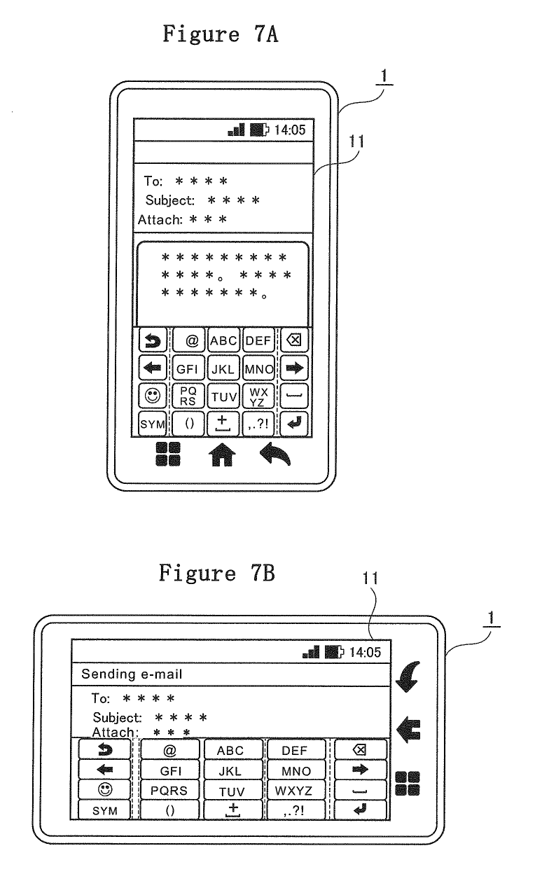

Assume that, as shown in FIG. 7A, a vertically oriented e-mail sending/receiving screen in accordance with an e-mail application is displayed on the display 11 of the mobile telephone handset 1. Since the sensitivity thereof is set to 25, the sensitivity is a poor value of 25/100 on the scale. Further, assume that, at step S4, the angle of inclination of the mobile telephone handset 1 is the angle α shown in FIG. 6B. Additionally assume that, at the sensitivity 25, the setting is made to switch the screen when the mobile telephone handset 1 is at an angle of α or greater.

If the mobile telephone handset 1 is tilted to an inclination of a or greater, the display controller 120 judges that the acceleration from the acceleration sensor 108 is at or above the sensitivity setting value, and judges that the mobile telephone handset 1 is at a horizontal orientation with respect to the ground (step S7). As a result, the display controller 120 performs control so as to switch the vertically oriented e-mail sending/receiving screen displayed on the display 11 in the horizontal direction as shown in FIG. 7B (step S8).

If, at step S5, the inclination of the mobile telephone handset 1 is less than α, at step S6 the display controller 120 judges that the acceleration from the acceleration sensor 108 is less than the sensitivity setting value, and does not judge that the mobile telephone handset 1 is in a horizontal orientation with respect to the ground (step S9). When this occurs, because the display controller 120 does not perform control so that the screen direction is switched, the e-mail sending/receiving screen on the display 11 remains in the vertical direction shown in FIG. 7A (step S10).

Conversely, the above also applies when the mobile telephone handset 1 is currently horizontal with respect to the ground, as shown in FIG. 6C, if the user tilts the mobile telephone handset so that the Y axis rotates in the direction toward the X axis by an angle of at least β, or if the inclination is made the less than the angle β, as shown in FIG. 6D, it is the same as the noted above, under the condition of β=α.

That is, if the mobile telephone handset 1 is inclined by an angle of at least β, the judgment is made that the acceleration from the acceleration sensor 108 is at least the sensitivity setting value (step S6), and the display controller 120 judges that the mobile telephone handset 1 is in a vertical orientation with respect to the ground (step S7). As a result, the display controller 120 performs control to switch the horizontally oriented e-mail sending/receiving screen displayed on the display 11 to a vertical orientation, as shown in FIG. 7A.

However, if, at step S4, the angle of inclination of the mobile telephone handset 1 is less than β, at step S6 the display controller 120 judges that the acceleration from the acceleration sensor 108 is less than the sensitivity setting value, and does not judge that the mobile telephone handset 1 is in a vertical orientation with respect to the ground (step S9). As a result, because the display controller 120 does not perform control to switch the display screen direction, the e-mail sending/receiving screen on the display 11 remains in the horizontal direction, as shown in FIG. 7B, that is, the current state is maintained (step S10).

In the same manner as the above, in DG3 for the browser application and DG4 for the map application, for which the acceleration sensor sensitivity settings are on, the display 11 display screen is controlled to switch to the vertical direction or to the horizontal direction, in accordance with the setting sensitivity of the acceleration sensor 108.

Although in the above-described examples β was taken as being equal to α, by making it possible to individually set the angle α for judging that the orientation of the mobile telephone handset 1 is horizontal with respect to the ground and the angle β for judging that the orientation of the mobile telephone handset 1 is vertical with respect to the ground, it is possible to make the angles different (β≠α).

### Effect of the Embodiment

According to the mobile telephone handset 1 of the present embodiment, by a variable setting of the sensitivity of the acceleration sensor 108, the angle of inclination of the mobile telephone handset 1 at which the display screen of the display 11 is switched to the vertical orientation or to horizontal orientation can be varied from the current state. In this case, if the setting is made to limit the sensitivity, if the user wishes a vertical display as much as possible, the user can tilt the mobile telephone handset 1 to a considerable angle from the vertical orientation toward the horizontal orientation without the vertical screen switching to the horizontal screen. By doing this, the flexibility of use of the mobile telephone handset 1 can be improved.

Also, it is possible by the operation unit to make an arbitrary setting of the set sensitivity of the acceleration sensor. By doing this, when the mobile telephone handset 1 is tilted, the angle of inclination at which the display screen of the display 11 is switched from the vertical orientation or to the horizontal orientation can be freely changed from the current state.

As a result, when the user desires a display on a vertical screen, if the mobile telephone handset 1 is not inclined from the vertical orientation toward the horizontal direction at greater than the desired angle, for example, not greater than 40 degrees, it is possible to make it so that the vertical screen does not switch to the horizontal screen. Stated differently, if the inclination is greater than 40 degrees, it is possible to switch the display from the vertical screen to the horizontal screen.

Additionally, the set sensitivity of the acceleration sensor is made to be set for each of a plurality of applications. As a result, if there is a display screen for an application that the user desires, for example, in the case of the e-mail sending/receiving screen, even if the mobile telephone handset 1 is tilted to a considerable angle from the vertical orientation toward the horizontal direction, it is possible to make it so that the vertical screen does not switch to the horizontal screen. That is, for each application, it is possible to arbitrarily set the angle of inclination at which the display screen switches from the vertical direction to the horizontal direction when the mobile telephone handset 1 is tilted.

Although the above has been a description using the example of a touch panel type mobile telephone handset 1 as the terminal device, the terminal device may be a keyboard-type mobile telephone handset, a PDA, a tablet PC, or an electronic dictionary terminal, which communicates, or a standalone-type electronic dictionary terminal or the like, which does not communicate.

Although the foregoing has been a description of a preferred embodiment of the present invention, it will be obvious that the anticipated technical scope of the present invention is not restricted to the above-noted anticipated scope of the embodiments. It will be clear to a person skilled in the art that the above-noted embodiment can be variously modified and improved. Also, it will be clear from the language in the claims that such modified and improved embodiments are encompassed in the anticipated technical scope of the present invention.

Additionally, memory or other storage, as well as communication components, may be employed in embodiments of the disclosure. It will be appreciated that, for clarity purposes, the above description has described embodiments of the disclosure with reference to different functional units and processors. However, it will be apparent that any suitable distribution of functionality between different functional units, processing logic elements or domains may be used without detracting from the disclosure. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. In addition, the inclusion of a feature in one category of claims does not imply a limitation to this category, but rather the feature may be equally applicable to other claim categories, as appropriate.

It will be appreciated that, for clarity purposes, the above description has described embodiments of the disclosure with reference to different functional units and processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

In this document, the terms “computer program product”, “computer-readable medium”, and the like may be used generally to refer to media such as, for example, memory, storage devices, or storage unit. These and other forms of computer-readable media may be involved in storing one or more instructions for use by the processor module to cause the processor module to perform specified operations. Such instructions, generally referred to as “computer program code” or “program code” (which may be grouped in the form of computer programs or other groupings), when executed, enable a grid-menu display-control method of the mobile device.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A terminal device comprising:
a display unit;
an acceleration sensor operable to sense an acceleration of a body of the terminal device when the body is being tilted;
a display controller operable to:
display a vertical screen on the display unit when the body is in a vertical orientation;
display a horizontal screen on the display unit when the body is in a horizontal orientation; and
switch between the vertical screen and the horizontal screen based on an output from the acceleration sensor; and
an operation unit operable to accept a setting of a sensitivity of the acceleration sensor,
wherein the display controller is operable to control switching based on the sensitivity and the acceleration.

2. The terminal device according to claim 1, wherein
the operating unit is further operable to accept a setting of the sensitivity to off, and
the display controller does not switch between the vertical screen and the horizontal screen if the sensitivity is set to off.

3. The terminal device according to claim 1, wherein
the operating unit is further operable to accept a setting of the sensitivity for each of a plurality of applications, and
the display controller is operable to switch between the vertical screen and the horizontal screen based on the setting for each of the plurality of applications.

4. The terminal device according to claim 1, wherein the sensitivity is associated with a corresponding angle of inclination of the body.

5. The terminal device according to claim 2, wherein the sensitivity is associated with a corresponding angle of inclination of the body.

6. The terminal device according to claim 3, wherein the sensitivity is associated with a corresponding angle of inclination of the body.

7. A method for operating a terminal device comprising:
displaying a vertical screen on a display unit when a body of the terminal device body is in a vertical orientation;
displaying a horizontal screen on the display unit when the body is in a horizontal orientation;
switching between the vertical screen and the horizontal screen based on an output from an acceleration sensor, operable to sense acceleration of the body when the body is being tilted;
accepting a setting of a sensitivity of the acceleration sensor; and
controlling switching between the vertical screen and the horizontal screen based on the sensitivity and the acceleration.

8. The method according to claim 7, further comprising:
accepting a setting of the sensitivity to off; and
not switching between the vertical screen and the horizontal screen if the sensitivity is set to off.

9. The method according to claim 7, further comprising:
accepting a setting of the sensitivity for each of a plurality of applications; and
switching between the vertical screen and the horizontal screen based on the setting.

10. The method according to claim 7, wherein the sensitivity is associated with a corresponding angle of inclination of the body.

11. The method according to claim 8, wherein the sensitivity is associated with a corresponding angle of inclination of the body.

12. The method according to claim 9, wherein the sensitivity is associated with a corresponding angle of inclination of the body.

13. A non-transitory computer readable storage medium comprising computer-executable instructions for operating a terminal device, the computer-executable instructions comprising:
displaying a vertical screen on a display unit when a body of the terminal device is in a vertical orientation;
displaying a horizontal screen on the display unit when the body is in a horizontal orientation;
switching between the vertical screen and the horizontal screen based on an output from an acceleration sensor, operable to sense acceleration of the body when the body is being tilted;
accepting a setting of a sensitivity of the acceleration sensor; and
controlling switching between the vertical screen and the horizontal screen based on the sensitivity and the acceleration.

14. The non-transitory computer readable storage medium of claim 13, further comprising:
accepting a setting of the sensitivity to off; and
not switching between the vertical screen and the horizontal screen if the sensitivity is set to off.

15. The non-transitory computer readable storage medium of claim 13, further comprising:
accepting a setting of the sensitivity for each of a plurality of applications; and
switching between the vertical screen and the horizontal screen based on the setting.

16. The non-transitory computer readable storage medium of claim 13, wherein the sensitivity is associated with a corresponding angle of inclination of the body.

17. The non-transitory computer readable storage medium of claim 14, wherein the sensitivity is associated with a corresponding angle of inclination of the body.

18. The non-transitory computer readable storage medium of claim 15, wherein the sensitivity is associated with a corresponding angle of inclination of the body.
